(19) United States
(12) Patent Application Publication
(10) Pub. No.: US 2022/0017772 A1
(43) Pub. Date: Jan. 20, 2022

(54) FIRE RESISTANT POLYURETHANE COATING COMPOSITION AND A FIRE-RESISTANT PRODUCT COMPRISING THE SAME

(71) Applicants: Dow Global Technologies LLC, Midland, MI (US); Rohm and Haas Company, Collegeville, PA (US)

(72) Inventors: Xiangyang Tai, Shanghai (CN); Rongbin Lan, Shanghai (CN); Juelin Liu, Shanghai (CN); Kshitish A. Patankar, Midland, MI (US); Charles J. Rand, Philadelphia, PA (US)

(21) Appl. No.: 17/296,619

(22) PCT Filed: Feb. 11, 2019
(86) PCT No.: PCT/CN2019/074787

§ 371 Date: May 25, 2021

(51) Int. Cl. C09D 175/08; C09D 5/18; C08G 18/48; C08G 18/54; C08G 18/40; C08G 18/76

(52) U.S. Cl. CPC C09D 175/08; C09D 5/185; C08G 18/4829; C08G 2150/60; C08G 18/4027; C08G 18/7671; C08G 18/542

(57) ABSTRACT

A fire-resistant polyurethane composition and a fire-resistant product comprising the fire-resistant polyurethane composition. The fire-resistant polyurethane coating composition comprises: an aromatic isocyanate component, a polyol component, and an intumescent component; wherein the aromatic structure in the polyurethane backbone is ≥24 wt %. The fire-resistant polyurethane composition could provide surprisingly good intumescent layer toughness as well as good insulation performance.

### FIELD OF THE INVENTION

The present disclosure relates to a fire resistant polyurethane coating composition and a fire-resistant product comprising the fire-resistant polyurethane coating composition.

### INTRODUCTION

Fire safety is one of major concerns for building materials and construction industry. Especially for easily combustible materials, like wood or materials which carry main loading of building, they need to be protected by a coating layer to delay the temperature rise. Although many commercially available fire-resistant coating products can help improve fire-performance, they do not provide much improvement in extending the time duration for wood or metal element to sustain structural loads in a fire event. To provide longer evacuation time for people in the building, it is demanded to extend the time duration of structural products to sustain structural loads in a fire event. The extension of protection is generally provided by intumescency of the coating layer, i.e., swelling IN SITU to generate a foamed structure which could insulate the heat transfer from outside to the substrate. The protection performance is determined by three factors: 1) swelling ratio, the higher the better; 2) foam structure, a close cell with a finer size provides better thermal insulation than an open cell with a larger size; 3) the toughness of the intumescent layer, the tougher the better. The swelling ratio and foam structure determine the insulation performance, and the toughness of the intumescent layer determines the protection durability. Since the intumescent layer has a certain weight, it tends to fall off from the substrate if the layer is not tough enough, and air turbulence during combustion enlarges the risk of falling off. Once the intumescent layer falls off, it could not protect the substrate effectively.

Therefore, there is a need to develop a coating composition for wood, ceramic or metal substrate, which could form intumescent layer with not only a good insulation performance but also a good toughness to ensure longer durability of protection.

We have developed a fire-resistant polyurethane composition, which could provide surprisingly good intumescent layer toughness as well as good insulation performance.

### SUMMARY OF THE INVENTION

The present disclosure provides a fire-resistant polyurethane coating composition, and a fire-resistant product comprising the fire-resistant polyurethane coating composition.

In a first aspect, the present disclosure provides a fire-resistant polyurethane coating composition comprising:

a. an aromatic isocyanate component;

b. a polyol component; and

c. an intumescent component;

wherein the aromatic structure content in the polyurethane backbone is ≥24 wt %, wherein “aromatic structure content in the polyurethane backbone” is defined as the percentage of all atoms' weight in the conjugated planar cyclic ring structure in the precursors to the sum of precursors to form the polyurethane, and precursors in the polyurethane coating composition include all polyols, isocyanates and prepolymers of isocyanates, if present.

In a second aspect, the present disclosure provides a fire-resistant product comprising a substrate and a fire-resistant polyurethane coating composition applied on the substrate, the fire-resistant polyurethane coating composition comprising:

a. an aromatic isocyanate component;

b. a polyol component;

c. an intumescent component;

wherein the aromatic structure content in the polyurethane backbone is ≥24 wt %, wherein “aromatic structure content in the polyurethane backbone” is defined as the percentage of all atoms' weight in the conjugated planar cyclic ring structure in the precursors to the sum of precursors to form the polyurethane, and precursors in the polyurethane coating composition include all polyols, isocyanates and prepolymers of isocyanates, if present.

### BRIEF DESCRIPTION OF DRAWINGS

FIG. 1 shows the scheme of a vertical radiation heat testing device (a) front view; (b) side view; and (c) top view.

FIG. 2 shows the ceramic tile back temperature of inventive example 1-4 and comparative example 1-2.

FIG. 3 showed the OSB back temperature curve of inventive example 5-11 and comparative example 3.

### DETAILED DESCRIPTION OF THE INVENTION

As disclosed herein, “and/or” means “and, or as an alternative”. All ranges include endpoints unless otherwise indicated.

As disclosed herein, the terms “composition”, “formulation” or “mixture” refer to a physical blend of different components, which is obtained by simply mixing different components by physical means.

“Wood product” is used to refer to a product manufactured from logs such as lumber (e.g., boards, dimension lumber, solid sawn lumber, joists, headers, trusses, beams, timbers, mouldings, laminated, finger jointed, or semi-finished lumber), composite wood products, or components of any of the aforementioned examples. The term “wood element” is used to refer to any type of wood product.

“Composite wood product” is used to refer to a range of derivative wood products which are manufactured by binding together the strands, particles, fibers, or veneers of wood, together with adhesives, to form composite materials. Examples of composite wood products include but are not limited to parallel strand lumber (PSL), oriented strand board (OSB), oriented strand lumber (OSL), laminated veneer lumber (LVL), laminated strand lumber (LSL), particleboard, medium density fiberboard (MDF) and hardboard.

“Intumescent particles” refer to materials that expand in volume and char when they are exposed to fire.

The word “coating”, “composition” and “formulation” can be substituted with each other and they have the same meaning for the purpose of this invention.

The term “the aromatic structure” is defined as a conjugated planar cyclic ring with at least two bonds reaching out to incorporate the structure into polyurethane backbone. The conjugated planar ring could be single 6-member ring benzene derivatives, it could be fused aromatics, like naphthalene derivatives, or it could also be polycyclic aromatics, like anthracene and phenanthrene derivatives. The aromatic structure could come from both isocyanate and polyol part as long as it is in the polyurethane backbone, rather than as a pendent group.

The term “aromatic structure content in the polyurethane backbone” is defined as the percentage of all atoms' weight in the conjugated planar cyclic ring structure in the precursors to the sum of precursors to form the polyurethane. Precursors in the polyurethane coating composition include all polyols, isocyanates and prepolymers of isocyanates (if present).

“substrate” is defined as a material on which a coating composition is applied.

The sum of the weight percentages of all the components in a composition equals to 100 wt %.

The Aromatic Isocyanate Component

The aromatic isocyanate may be a single aromatic isocyanate or mixtures of such compounds. Examples of the aromatic isocyanates include toluene diisocyanate (TDI), monomeric methylene diphenyldiisocyanate (MDI), polymeric methylenediphenyldiisocyanate (pMDI), 1,5′-naphthalenediisocyante, and prepolymers of TDI, prepolymers of MDI or prepolymers of pMDI. Prepolymers of TDI, prepolymers of MDI or prepolymers of pMDI are typically made by reaction of TDI, MDI, or pMDI with less than stoichiometric amounts of multifunctional polyols.

The aromatic isocyanate component may be present in a quantity ranging from about 10% to about 30% by weight of the composition, preferably about 12% to about 25% by weight of the composition, more preferably about 14% to about 20% by weight of the composition.

Polyol Component

Preferably, the polyol component comprises aromatic polyol, more preferably Novolac type polyol component. The polyol component may further comprise other polyol component selected from non-Novolac type polyether polyol, polyester polyol, castor oil, soybean oil based polyol, a combination thereof.

Novolac Type Polyol Component

Novolac type polyol is an aromatic resin-initiated propylene oxide-ethylene oxide polyol, such as IP 585 polyol available from the Dow Chemical Company.

It may be prepared by alkoxylating propylene oxide or ethylene oxide in the existence of a catalyst, using novolac phenol as an initiator. The scheme is described as below, x=1-10, y, z=0-30, y+z=1-60.

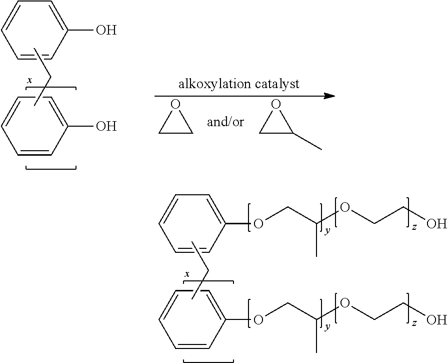

The Novolac type polyol component may be present in a quantity ranging from about 5% to about 40% by weight of the composition. In a preferred embodiment, the Novolac type polyol component may be present in a quantity ranging from about 8% to about 35% by weight of the composition. In a preferred embodiment, the Novolac type polyol component may be present in a quantity ranging from about 10% to about 30% by weight of the composition.

Other Polyol Component

The composition may further comprise other polyols selected from non-Novolac type polyether polyol, polyester polyol, castor oil, soybean oil based polyol, a combination thereof and the like.

Non-Novolac type polyether polyols can be the addition polymerization products and the graft products of ethylene oxide, propylene oxide, tetrahydrofuran, and butylene oxide, the condensation products of polyhydric alcohols, and any combinations thereof. Suitable examples of the polyether polyols include, but are not limited to, polypropylene glycol (PPG), polyethylene glycol (PEG), polybutylene glycol, polytetramethylene ether glycol (PTMEG), and any combinations thereof. In some embodiments, the polyether polyols are the combinations of PEG and at least one another polyether polyol selected from the above described addition polymerization and graft products, and the condensation products. In some embodiments, the polyether polyols are the combinations of PEG and at least one of PPG, polybutylene glycol, and PTMEG.

The polyester polyols are the condensation products or their derivatives of diols, and dicarboxylic acids and their derivatives. Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl-1,3-propandiol, 1,3-butanediol, 1,4-butanediol, 1,6-hexanediol, neopentyl glycol, 3-methyl-1,5-pentandiol, and any combinations thereof. In order to achieve a polyol functionality of greater than 2, triols and/or tetraols may also be used. Suitable examples of such triols include, but are not limited to, trimethylolpropane and glycerol. Suitable examples of such tetraols include, but are not limited to, erythritol and pentaerythritol. Dicarboxylic acids are selected from aromatic acids, aliphatic acids, and the combination thereof. Suitable examples of the aromatic acids include, but are not limited to, phthalic acid, isophthalic acid, and terephthalic acid; while suitable examples of the aliphatic acids include, but are not limited to, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, and 2,2-dimethyl succinic acid. Anhydrides of these acids can likewise be used. For the purposes of the present disclosure, the anhydrides are accordingly encompassed by the expression of term “acid”. In some embodiments, the aliphatic acids and aromatic acids are saturated, and are respectively adipic acid and isophthalic acid. Monocarboxylic acids, such as benzoic acid and hexane carboxylic acid, should be minimized or excluded.

Polyester polyols can also be prepared by addition polymerization of lactone with diols, triols and/or tetraols. Suitable examples of lactone include, but are not limited to, caprolactone, butyrolactone and valerolactone. Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl 1,3-propandiol, 1,3-butanediol, 1,4-butanediol, 1,6-hexanediol, neopentyl glycol, 3-methyl 1,5-pentandiol and any combinations thereof. Suitable examples of triols include, but are not limited to, trimethylolpropane and glycerol. Suitable examples of tetraols include erythritol and pentaerythritol.

Castor oil is a mixture of triglyceride compounds obtained from pressing castor seed. About 85 to about 95% of the side chains in the triglyceride compounds are ricinoleic acid and about 2 to 6% are oleic acid and about 1 to 5% are linoleic acid. Other side chains that are commonly present at levels of about 1% or less include linolenic acid, stearic acid, palmitic acid, and dihydroxystearic acid.

Natural oil based polyol is a chemically modified mixture of triglyceride compounds obtained from seeds oil, like soybean. Double bonds is natural oil is chemically converted to polyol to make the compounds containing 2, 3 or more hydroxyl group in one molecule.

The other polyol component may be present in a quantity ranging from about 1% to about 50% by weight of the composition. In a preferred embodiment, the other polyol component may be present in a quantity ranging from about 3% to about 45% by weight of the composition. In a preferred embodiment, the other polyol component may be present in a quantity ranging from about 5% to about 40% by weight of the composition. In a preferred embodiment, the other polyol component may be present in a quantity ranging from about 5% to about 30% by weight of the composition.

Intumescent Component

The intumescent component may be present in a quantity ranging from about 1% to about 50% by weight of the total composition. In a preferred embodiment, the intumescent component is present in a quantity ranging from about 10% to about 40% by weight of the composition, or is present in a quantity ranging from about 15% to about 35% by weight of the composition. The intumescent component may be intumescent particles.

Intumescent particles suitable for use with embodiments of the disclosure include expandable graphite, which is graphite that has been loaded with an acidic expansion agent (generally referred to as an “intercalant”) between the parallel planes of carbon that constitute the graphite structure. When the treated graphite is heated to a critical temperature, the intercalant decomposes into gaseous products and causes the graphite to undergo substantial volumetric expansion. Manufacturers of expandable graphite include GrafTech International Holding Incorporated (Parma, Ohio). Specific expandable graphite products from GrafTech include those known as Grafguard 160-50, Grafguard 220-50 and Grafguard 160-80. Other manufacturers of expandable graphite include HP Materials Solutions, Incorporated (Woodland Hills, Calif.). There are multiple manufacturers of expandable graphite in China and these products are distributed within North America by companies that include Asbury Carbons (Sunbury, Pa.) and the Global Minerals Corporation (Bethseda, Md.). Further, other types of intumescent particles known to a person of ordinary skill in the art would be suitable for use with embodiments of the disclosure. Preferably, the intumescent components are insoluble in water.

Catalysts

Catalysts may include urethane reaction catalysts and isocyanate trimerization reaction catalysts.

Trimerization catalysts may be any trimerization catalyst known in the art that will catalyze the trimerization of an organic isocyanate compound. Trimerization of isocyanates may yield polyisocyanurate compounds inside the polyurethane foam. Without being limited to theory, the polyisocyanurate compounds may make the polyurethane foam more rigid and provide improved reaction to fire. Trimerization catalysts can include, for example, glycine salts, tertiary amine trimerization catalysts, alkali metal carboxylic acid salts, and mixtures thereof. In some embodiments, sodium N-2-hydroxy-5-nonylphenyl-methyl-N-methylglycinate may be employed. When used, the trimerization catalyst may be present in an amount of 0.5-2 wt %, preferably 0.8-1.5 wt % of the “polyol package”.

Tertiary amine catalysts include organic compounds that contain at least one tertiary nitrogen atom and are capable of catalyzing the hydroxyl/isocyanate reaction between the isocyanate component and the isocyanate reacting mixture. Tertiary amine catalysts can include, by way of example and not limitation, triethylenediamine, tetramethylethylenediamine, pentamethyldiethylene triamine, bis(2-dimethylaminoethyl)ether, triethylamine, tripropylamine, tributylamine, triamylamine, pyridine, quinoline, dimethylpiperazine, piperazine, N-ethylmorpholine, 2-methylpropanediamine, methyltriethylenediamine, 2,4,6-tridimethylamino-methyl)phenol, N, N′, N″-tris(dimethyl amino-propyl)sym-hexahydrotriazine, and mixtures thereof. When used, the tertiary amine catalyst may be present in an amount of 0.5-2 wt %, preferably 0.8-1.5 wt % of the “polyol package”.

The composition of the present disclosure may further comprise the following catalysts: tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride, stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt.

The total amount of the catalyst component used herein may range generally from about 0.01 wt % to about 10 wt % based on the weight of the composition, preferably 0.5 wt % to about 5 wt % based on the weight of the composition.

Other Additives

Other optional compounds or additives may be added to the composition of the present invention.

The additives may be present in a quantity ranging from about 0% to about 30% by weight of the composition, preferably about 10% to about 20% by weight of the composition.

Additives that may be incorporated into the fire retardant polyurethane composition to achieve beneficial effects include but are not limited to surfactants (usually silicon type), wetting agents, opacifying agents, colorants, viscosifying agents, preservatives, fillers and pigments (include, in non-limiting embodiments, barium sulfate, calcium carbonate, graphite, carbon black, titanium dioxide, iron oxide, microspheres, alumina trihydrate, wollastonite, glass fibers, polyester fibers, other polymeric fibers, combinations thereof, and the like), leveling agents, defoaming agents, thickeners such as silicon dioxide, diluents, hydrated compounds, halogenated compounds, moisture scavenger (for example molecular sieves, aldimines or p-toluenesulfonyl isocyanate), acids, bases, salts, borates, melamine and other additives that might promote the production, storage, processing, application, function, cost and/or appearance of this fire retardant coating for wood products.

Additional flame-retardant components may be added to the composition to enhance the flame-retardant properties of the coating. For example, a halogenated flame retardant may be added to reduce flame spread and smoke production when the coating is exposed to fire. Halogenated flame retardants prevent oxygen from reacting with combustible gasses that evolve from the heated substrate, and react with free radicals to slow free radical combustion processes. Examples of suitable halogenated flame-retardant compounds include chlorinated paraffin, decabromodipheyloxide, available from the Albermarle Corporation under the trade name SAYTEX 102E, and ethylene bis-tetrabromophthalimide, also available from the Albermarle Corporation under the trade name SAYTEX BT-93. The halogenated flame-retardant compound is typically added to the coating in a quantity of 0-5% of the coating by weight, although greater amounts may also be used. Often, it is desirable to use the halogenated flame-retardant compound in combination with a synergist that increases the overall flame-retardant properties of the halogenated compound. Suitable synergists include zinc hydroxy stannate and antimony trioxide. Typically, these synergists are added to the coating in a quantity of 1 part per 2-3 parts halogenated flame retardant by weight, though more or less may also be used. In addition, phosphorus-containing flame retardants such as ammonium polyphosphate, or melamine polyphosphate, or other polyphosphate in powder shape, or aromatic condensed phosphate, such as resorcinol bis(diphenylphosphate) (RDP) and bisphenol A bis(diphenylphosphate) (BPA-BDPP) or the combination thereof can also be added to the composition to enhance the flame-retardant properties of the coating. Preferably, the aromatic condensed phosphate is resorcinol bis(diphenylphosphate) (RDP). More preferably, the total amount of phosphorus-containing flame retardant used herein may range generally from about 1 wt % to about 40 wt % based on the weight of the composition, preferably 5 wt % to about 30 wt % based on the weight of the composition, preferably 7 wt % to about 20 wt % based on the weight of the composition.

Preferably, the flame-retardant additives are insoluble in water.

It is surprisingly discovered that only when the overall aromatic structure content in the polyurethane backbone is ≥24 wt % could the intumescent layer generated in fire providing enough toughness for durable insulation protection. For PU composition with aromatic structure content <24 wt %, the intumescent char does not have adequate mechanical strength to withstand any mechanical shock, like shaking or air turbulence, and therefore has poor durability in a real fire event. Preferably, the aromatic structure content in the polyurethane backbone is ≥25 wt %, ≥26 wt %, ≥27 wt %, ≥28 wt %, ≥29 wt %, ≥30 wt %, ≥32 wt % or ≥35 wt %. The aromatic structure content in the polyurethane backbone is less than 70 wt %, preferably less than 60 wt %, preferably less than 50 wt % or less than 45 wt %.

Preparation of Composition

The components described above may be combined using a number of different techniques. In some embodiments, intumescent particles are dispersed in the polyol along with other additives to form a relatively stable suspension, which can be shipped and stored for a period of time until it is ready to be used. Such a mixture can be referred to in this disclosure as the “polyol component”. The aromatic isocyanate component (e.g., aromatic isocyanate or mixture of aromatic isocyanates) is generally stable and can be shipped and stored for prolonged periods of time as long as it is protected from water and other nucleophilic compounds. Such a mixture can be referred to in this disclosure as the “aromatic isocyanate component”. Prior to application, these two components may be mixed together. This particular formulating strategy results in a polyurethane matrix with a suitable level of elasticity for use as a fire-resistant coating. Further, in some embodiments, other advantages may be realized. For example, the prepolymers of TDI or pMDI can have beneficial effects on the elasticity of the polymer matrix and they can alter the surface tension of uncured liquid components so that the intumescent particles tend to remain more uniformly suspended when the polyol and isocyanate components are combined just prior to application.

Prior to application of the composition to the substrate, mixing of the reactive components, especially the polyol and the aromatic isocyanate compounds, should be performed. In one embodiment the intumescent particles can be suspended in polyol along with the other composition additives to make a stable liquid suspension, which can later be combined with the aromatic isocyanate compounds. Accordingly, the two liquid components can be combined at the proper ratio and mixed by use of meter-mixing equipment, such as that commercially available from The Willamette Valley Company (Eugene, Oreg.) or GRACO Incorporated (Minneapolis, Minn.) or ESCO (edge sweets company). In some embodiments, three or more components (isocyanate-reactive component, intumescent, and aromatic isocyanates) can all be combined using powder/liquid mixing technology just prior to application. In some embodiments, the formulation has a limited “pot-life” and should be applied shortly after preparation. Thereafter, the formulation subsequently cures to form a protective coating that exhibits performance attributes as a fire-resistant coating for wood products.

In the absence of a catalyst, the complete formulation may be applied to a substrate in less than about 30 minutes after preparation. It is possible to increase the mixed pot-life by decreasing the temperature of the formulation mixture or by use of diluents or stabilizers such as Phosphoric acid. When catalysts are used in the formulation, the mixed pot-life can be less than about 30 minutes. Examples of catalysts include organometallic compounds, such as dibutyltin dilaurate, stannous octoate, dibutyltin mercaptide, lead octoate, potassium acetate/octoate, and ferric acetylacetonate; and tertiary amine catalysts, such as N,N-dimethylethanolamine, N,N-dimethylcyclohexylamine, 1,4-diazobicyclo[2.2.2]octane, 1-(bis(3-dimethylaminopropyl)amino-2-propanol, N,N-diethylpiperazine, DABCO TMR-7, and TMR-2.

Application of Composition

Compositions according to embodiments of the disclosure may be applied to a substrate, such as a wood product, a composite wood product or ceramic. Generally, compositions according to embodiments of the disclosure are applied to one or more surfaces of a substrate at an application level of about 0.05 to about 3.0 lb/ft², preferably about 0.1 to about 2.0 lb/ft², preferably about 0.1 to about 0.5 lb/ft². The composition of the present invention may be applied in a variety of manners, such as spraying, knife over roll coating, or draw down using a Gardco Casting Knife Film Applicator.

The fire-resistant product comprising the fire-resistant polyurethane coating composition of the present application is selected from wood, metal, ceramic, polymeric materials, or concrete.

### EXAMPLES

Some embodiments of the invention will now be described in the following Examples, wherein all parts and percentages are by weight unless otherwise specified.

I. Raw Materials

The raw materials and components used the invented fire resistant polyurethane coating compositions are list in Table 1.

TABLE 1
Raw Materials used in this invention

| Raw Material | Description | Supplier |
|---|---|---|
| Voranol 2100 | polyether polyol, | Dow Chemical |
| | HO-EW = 1002, | |
| | Functionality = 3 | |
| Voranol 2120 | polyether polyol, | Dow Chemical |
| | HO-EW = 1000, | |
| | Functionality = 2 | |
| Voranol 2140 | polyether polyol, | Dow Chemical |
| | HO-EW = 2011, | |
| | Functionality = 2 | |
| Voranol CP6001 | polyether polyol, | Dow Chemical |
| | HO-EW = 1002, | |
| | Functionality = 3 | |
| Voranol IP-585 | Phenol Novolac based | Dow Chemical |
| | polyether polyol, | |
| | HO-EW = 286, | |
| | Functionality = 3.4, | |
| | aromatics = 26.57 wt % | |
| Resorcinol bis(diphenyl | WSFR-RDP | Wansheng Chemical |
| phosphate) (RDP) | | |
| TiO₂ | R-706, mean particle | Dupont |
| | size 0.136 micron | |
| Silicone copolymer | Niax Silicone L6900 | Momentive |
| L6900 | | |
| Silicone surfactant | Dabco DC193 | Air Product |
| DC-193 | | |
| Precipitated silica | VK-SP50, Particle size | Hangzhou Wanjing |
| | 50-100 nm | New Material Co. |
| | | Ltd |
| Aluminum hydroxide | Martinal OL-104C, | Albemarle |
| (ATH) | Mean particle size ~1 | |
| | micron. | |
| Expandable Graphite | Graft-Guard 160-50N | GrafTech |
| Dibutlytin dilaurate | Dabco T-12 catalyst | Air Product |
| Tertiary amine catalyst | Dabco TMR-2 | Air Product |
| Tertiary amine catalyst | Dabco TMR-7 | Air Product |
| Benzoic acid | Analytical purity | SCRC |
| polyMDI | PAPI 27, NCO-EW: | Dow Chemical |
| | 133.5. Aromatics = | |
| | 56.93 wt % | |
| MDI OP 50 | Desmodur 2460M, | Covestro |
| | NCO-EW: 126.5. | |
| | Functionality = 2. | |
| | Aromatics = 60.08 wt % | |

### Inventive Example 1-4 and Comparative Example 1-2 (Ceramic Tile Coating)

To 120 ml polyethylene cup with an inner diameter of 4.5 cm and a height of 6.3 cm, equipped with a high-speed mixer with an out-diameter of 3.5 cm, were added polyol, expandable graphite, RDP, TiO₂, a surfactant, ATH, and a catalyst in turn. The mixer speed was adjusted to 300 rpm for homogeneous distribution of powders in liquid. After running for 3 min, the mixer speed was increased to 1500 rpm and ran for 5 min. Isocyanate was added and the mixer ran for additional 1 min under 1000 rpm.

Right after the mixing, the slurry was applied onto a 10 cm×10 cm×0.6 cm ceramic tile. The composition was applied with blade coating with a wet film thickness of 1.5 mm. The coated ceramic tile was put into a fume hood at room temperature (25±2° C.) and a relative humidity ˜50% for at least 3 consecutive days.

Formulations of inventive example 1-4 and comparative example 1-2 are listed in Table 2.

TABLE 2
Formulations of inventive example 1-4 and comparative example 1-2

| | Inventive | Inventive | Inventive | Inventive | Comparative | Comparative |
|---|---|---|---|---|---|---|
| | Example 1 | Example 2 | Example 3 | Example 4 | Example 1 | Example 2 |
| Voranol 2120 | | | | | 20.00 | 14.50 |
| Voranol 2140 | 10.90 | 10.90 | 5.90 | 5.90 | 15.00 | 10.90 |
| Voranol IP-585 | 14.50 | 14.50 | 19.50 | 16.50 | | |
| RDP | 15.00 | 15.00 | 15.00 | 18.00 | 13.23 | 15.00 |
| TiO2 | | | | | 1.14 | |
| Surfactant (L6900) | | | | | 0.16 | |
| surfactant DC-193 | 0.15 | 0.15 | 0.15 | 0.15 | | 0.15 |
| Precipitated silica | | | | | 3.00 | |
| ATH | 20.00 | 20.00 | 20.00 | 20.00 | | 20.00 |
| Expandable Graphite | 25.00 | 25.00 | 25.00 | 25.00 | 27.00 | 25.00 |
| TMR-7 | | 0.15 | | | | |
| Benzoic acid | | | 0.20 | 0.20 | | |
| MDI OP 50 | 14.60 | 14.60 | 14.60 | 14.60 | 20.47 | 14.60 |
| Sum | 100.15 | 100.30 | 100.35 | 100.35 | 100.00 | 100.15 |
| Aromatics wt % in | 31.56 | 31.56 | 34.88 | 35.56 | 22.17 | 21.93 |
| polyurethane backbone | | | | | | |

Notes:
the aromatic content are calculated as follows:
Aromatic content calculation for Voranol IP585:
OH equivalent = 286
For one OH group, there is one benzyl ring, Mw = 76
Benzyl ring in IP585 = 76/286 = 0.2657.
For pMDI
NCO equivalent = 133.5
For one NCO group, there is one benzyl ring, Mw = 76
Benzyl ring in IP585 = 76/133.5 = 0.5693.
For MDI OP50
NCO equivalent = 126.5
For one NCO group, there is one benzyl ring, Mw = 76
Benzyl ring in IP585 = 76/126.5 = 0.6008.
Aromatic content in inventive example 1:
Voranol 2140 contribution = 0
Voranol IP-585 contribution = 14.5*0.2657 = 3.8527
MDI IP50 contribution = 14.6*0.6008 = 8.7717
Total aromatic contribution = 3.8527 + 8.7717 = 12.6244
Total polyurethane backbone in formulation = 10.9 + 14.5 + 14.6 = 40
Total aromatic content in polyurethane precursors = 12.6244/40 *100 = 31.56%
All are calculated based on weight.

### Inventive Example 5-11 and Comparative Example 3 (OSB Board Coating)

To 120 ml polyethylene cup with an inner diameter of 4.5 cm and a height of 6.3 cm, equipped with a high-speed mixer with an out-diameter of 3.5 cm, were added polyol, expandable graphite, RDP, TiO₂, a surfactant, ATH, and a catalyst in turn. The mixer speed was adjusted to 300 rpm for homogeneous distribution of powders in liquid. After running for 3 min, the mixer speed was increased to 1500 rpm and ran for 5 min. Isocyanate was added and the mixer ran for additional 1 min under 1000 rpm.

Right after the mixing, the slurry was applied onto 10 cm×10 cm×0.9 cm pine OSB board (oriented strand board). The composition was applied with blade coating with a wet film thickness of 1.5 mm. The coated OSB board was put into a fume hood at room temperature (25±2° C.) and a relative humidity ˜50% for at least 3 consecutive days.

Formulations of inventive example 5-11 and comparative example 3 are listed in Table 3.

TABLE 3
Formulation of inventive example 5-11 and comparative example 3

| | Inventive | Inventive | Inventive | Inventive | Inventive | Inventive | Inventive | Comparative |
|---|---|---|---|---|---|---|---|---|
| | Example 5 | Example 6 | Example 7 | Example 8 | Example 9 | Example 10 | Example 11 | Example 3 |
| Voranol 2100 | | | | | | | | 20.00 |
| Voranol 2140 | 10.90 | 5.90 | 10.00 | 20.00 | 22.00 | 22.00 | 10.90 | |
| Voranol CP6001 | | | | | | | | 15.00 |
| Voranol IP-585 | 14.50 | 19.50 | 30.00 | 20.00 | 20.00 | 20.00 | 14.50 | |
| RDP | 15.00 | 15.00 | | | 13.00 | 13.00 | 15.00 | 13.23 |
| TiO2 | | | | | | | | 1.14 |
| Surfactant (L6900) | | | | | | | | 0.16 |
| surfactant DC-193 | 0.15 | 0.15 | 0.15 | 0.15 | 0.15 | 0.15 | 0.15 | |
| Precipitated silica | | | | | | | | 3.00 |
| ATH | 20.00 | 20.00 | | | | | | |
| Expandable Graphite | 25.00 | 25.00 | 30.00 | 30.00 | 27.00 | 27.00 | 25.00 | 27.00 |
| Budit FR CROS 486 | | | | | | | 20.00 | |
| T-12 | | | | | | 0.84 | 0.51 | |
| TMR-2 | | | | | | 0.27 | 0.22 | |
| PAPI 27 | | | 30.00 | 30.00 | 18.00 | 18.00 | 14.60 | |
| MDI OP 50 | 14.60 | 14.60 | | | | | | 20.47 |
| Sum | 100.15 | 100.15 | 100.15 | 100.15 | 100.15 | 101.26 | 100.88 | 100.00 |
| Aromatics wt % in | 31.56 | 34.88 | 35.79 | 31.99 | 25.94 | 25.94 | 30.41 | 22.17 |
| polyurethane backbone | | | | | | | | |

Evaluation Method of PU Coating Composition's Fire Protection Performance

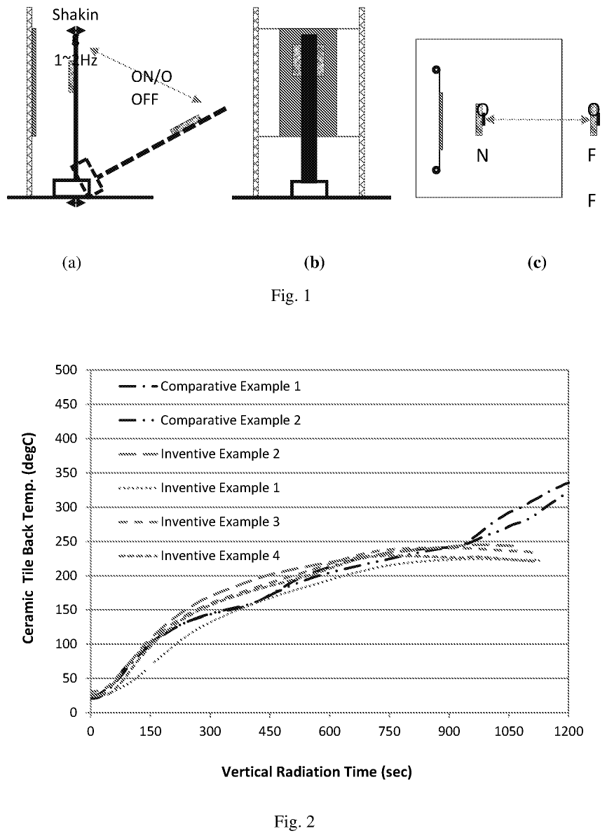

A special device of vertical radiation heater was designed and fabricated for fire protection evaluation. The scheme of the device is shown in FIG. 1. The whole device was installed in a flame resistant chamber equipped with forced ventilation to exhaust smoke and gas generated in the test. The heater (as shown in red block) has power output as 3000 W, made by assembling Fe—Ni alloy filament into 18 cm×28 cm panel. The radiation panel was fixed on a stainless steel stage, facing sample to be tested. The sample holder was designed to fix the sample facing the radiation panel with face to face distance at 10 cm. The sample holder could lay down to 30° to keep the sample far away from radiation (“OFF” position) and stand to face the radiation panel to start the test (“ON” position). A thermal couple was placed on the center of the back of substrate to record the back temperature during radiation heating. After a period of radiation, the sample holder was shaken horizontally in 60-120 times per min frequency to check if the intumescent layer would fall down or not. If the cohesion in the intumescent layer or adhesion of intumescent layer to substrate was not good enough to hold the layer, it would fall down like a square blanket of part of the blanket. The phenomena during shaking were recorded. After shaking, the sample holder was laid off to stop the test. The intumescent layer residual together with the substrate was cooled down. The cool intumescent layer was broken by finger. Depending on the force to break the intumescent layer, its toughness was ranked from 1 to 10. 1 meant very floppy, to be broken by slight finger touch, could not withstand any obvious force. 10 meant very tough, with obvious modulus and elasticity, to be broken by considerable force. Both shaking phenomena and toughness ranking were used to evaluate the intumescent layer toughness.

PU Coating Composition's Fire Protection Performance on Ceramic Tiles

According to the designed evaluation method, PU coated ceramic tiles described in inventive example 1-4 and comparative example 1-2 were tested. Intumescent layer falling phenomena during shaking after 15 min radiation, and intumescent layer toughness ranking were recorded in Table 4, as well as back temperature at 120 sec, 300 sec, 600 sec, and 900 sec respectively. Back temperature profile curve for all samples was shown in FIG. 2.

TABLE 4
Fire protection performance of inventive example 1-4 and comparative example 1-2

| | Inventive | Inventive | Inventive | Inventive | Comparative | Comparative |
|---|---|---|---|---|---|---|
| | Example 1 | Example 2 | Example 3 | Example 4 | Example 1 | Example 2 |
| Intumescent Layer Falling During Shaking | No Falling | No Falling | No Falling | No Falling | Blanket Falling* | Blanket Falling* |
| Intumscent Layer Toughness Ranking | 8 | 9 | 10 | 8 | 1 | 1 |
| Ceramic tile Back temp. at 120 sec (° C.) | 53.4 | 88.9 | 86.9 | 77.2 | 83.1 | 87.5 |
| Ceramic tile Back temp. at 300 sec (° C.) | 132 | 169.7 | 159.3 | 156.9 | 144.5 | 143.5 |
| Ceramic tile Back temp. at 600 sec (° C.) | 193.8 | 219.6 | 217.3 | 210.5 | 212.7 | 204.4 |
| Ceramic tile Back temp. at 900 sec (° C.) | 223.3 | 242.3 | 240.7 | 226.8 | 241.3 | 241.3 |

*Blanket falling: Intumescent layer facing the radiation panel fell off in square shape (10 cm × 10 cm) like blanket.

During the radiation heating test, coating layers on all samples swelled and generated intumescent layer, which protected the ceramic substrate and delayed heat transfer. After 15 min. radiation, the sample holder was shaken, all two comparative samples with overall aromatics lower than 24 wt %, and not comprising Novolac type polyol (Voranol IP585), had the top intumescent layer falling like blanket (the whole square shake). Thereafter back temperature curves headed up rapidly due to falling off intumescent layer and therefore the deterioration of insulation protection performance. After cooling down, it was found that the intumescent layer was very floppy, could not withstand finger press with very small force.

On the contrary, none of the inventive samples showed any changes during shaking. With the increase of aromatics content in the polyurethane backbone by replacing Voranol 2140 with Voranol IP585, the toughness of intumescent layer was significantly improved, from ranking 2 (comparative example 2) to ranking 8 (inventive example 1), and the intumescent layer became very tough, showing some elasticity. The toughness of intumescent layer increased accordingly when further increasing the aromatics content in polyurethane backbone, as shown in inventive example 2, 3 and 4, no matter the addition of catalyst or acid to tune the curing kinetics.

PU Coating Composition's Fire Protection Performance on OSB Wood Board

During the vertical radiation testing, all PU coating layers on OSB board swelled and formed intumescent layer. However, comparative example 3 showed layer by layer blanket falling even without shaking. The fallen materials collapsed on the stage. Shaking after radiation took off some intumescent char, with little char remained on OSB substrate. After cooling down, the char toughness was checked by finger touch, it could not withstand finger press with very small force, therefore, ranking as “2”. On the contrary, as shown in inventive examples, by having Novolac type polyol in the formulation, and increasing the aromatics content in polyurethane backbone to above 24 wt % through either replacing non-aromatic polyether polyol with aromatic polyether polyol (inventive example 5, 6, 9, 10 and 11), or increasing the dosage of aromatic isocyanate (inventive example 7 and 8), the toughness of intumescent layer increased significantly. All inventive examples did not show falling of intumescent layer either during the radiation, or during shaking after radiation.

TABLE 5
Fire protection performance of inventive example 5-11 and comparative example 3

| | Inventive | Inventive | Inventive | Inventive | Inventive | Inventive | Inventive | Comparative |
|---|---|---|---|---|---|---|---|---|
| | Example 5 | Example 6 | Example 7 | Example 8 | Example 9 | Example 10 | Example 11 | Example 3 |
| Intumescent Layer Falling During Shaking | No Falling | No Falling | No Falling | No Falling | No Falling | No Falling | No Falling | Falling layer by |
| | | | | | | | | layer in radiation |
| Intumscent Layer Toughness Ranking | 6 | 8 | 8 | 9 | 8 | 8 | 8 | 2 |
| OSB Back temp. at 120 sec (° C.) | 54.6 | 61.2 | 55.3 | 34.5 | 31.1 | 31.9 | 34.6 | 40.7 |
| OSB Back temp. at 300 sec (° C.) | 83.8 | 84.1 | 81.9 | 80.6 | 80.7 | 82.1 | 73.1 | 81.9 |
| OSB Back temp. at 600 sec (° C.) | 110.4 | 106.0 | 118.2 | 99.7 | 92.8 | 92.6 | 90.0 | 96.0 |
| OSB Back temp. at 900 sec (° C.) | 178.6 | 148.4 | 192.6 | 169.8 | 139.4 | 139.7 | 109.9 | 258.8 |

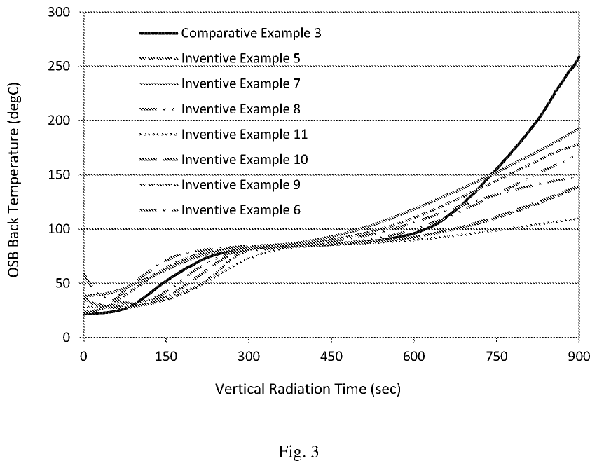

As the result of toughness increase of intumescent layer, the foam char could withstand possible deformation of OSB substrate, and provide better protection durability. OSB back temperature of inventive examples at 900 sec was dramatically lower than that of comparative example 3. FIG. 3 showed the OSB back temperature curve of inventive example 5-11 and comparative example 3. All inventive examples showed slow increase of temperature after 380 sec. On the contrary, comparative example 3 showed head up after 600 sec due to its lower aromatics content in polyurethane backbone and therefore layer by layer falling of char, which means deterioration of protection durability.

From the comparison between inventive examples and comparative examples, it is discovered that in PU coating composition with expendable graphite as swelling type of additive, only when the overall aromatic structure content in polyurethane backbone is ≥24 wt % could the intumescent layer generated in fire providing enough toughness for durable insulation protection. For PU composition with aromatic structure content <24 wt %, the intumescent char is too floppy to withstand any mechanical shock, like shaking or air turbulence, and therefore has poor protection durability.

1. A fire-resistant polyurethane coating composition comprising:
a. an aromatic isocyanate component;
b. a polyol component; and
c. an intumescent component;
wherein the aromatic structure content in the polyurethane backbone is ≥24 wt %, wherein “aromatic structure content in the polyurethane backbone” is defined as the percentage of all atoms' weight in the conjugated planar cyclic ring structure in the precursors to the sum of precursors to form the polyurethane, and precursors in the polyurethane coating composition include all polyols, isocyanates and prepolymers of isocyanates, if present.

2. The fire-resistant polyurethane coating composition of claim 1, wherein the aromatic isocyanates are selected from the group consisting of toluene diisocyanate (TDI), methylene diphenyldiisocyanate (MDI), polymeric methylenediphenyldiisocyanate (pMDI), 1,5′-naphthalenediisocyante, prepolymers of TDI, prepolymers of MDI and prepolymers of pMDI.

3. The fire-resistant polyurethane coating composition of claim 1, wherein the aromatic isocyanate component is present in a quantity ranging from about 10% to about 30% by weight of the composition.

4. The fire-resistant polyurethane coating composition of claim 1, wherein the polyol component comprises aromatic polyol, and the aromatic polyol is preferably Novolac type polyol component.

5. The fire-resistant polyurethane coating composition of claim 1, wherein the polyol component comprises Novolac type polyol component.

6. The fire-resistant polyurethane coating composition of claim 5, wherein the Novolac type polyol component is present in a quantity ranging from about 5% to about 40% by weight of the composition.

7. The fire-resistant polyurethane coating composition of claim 1, wherein the composition further comprises other polyols selected from non-Novolac type polyether polyol, polyester polyol, or a combination thereof.

8. The fire-resistant polyurethane coating composition of claim 1, wherein the intumescent component is present in a quantity ranging from about 1% to about 50% by weight of the total composition.

9. The fire-resistant polyurethane coating composition of claim 1, wherein the intumescent component comprises or is expandable graphite.

10. The fire-resistant polyurethane coating composition of claim 1, wherein the coating composition further comprises a catalyst.

11. The fire-resistant polyurethane coating composition of claim 1, wherein the coating composition further comprises additives selected from surfactants, wetting agents, opacifying agents, colorants, viscosifying agents, preservatives, fillers and pigments, leveling agents, defoaming agents, thickeners, diluents, hydrated compounds, halogenated compounds, moisture scavenger, acids, bases, salts, borates, melamine and phosphorus-containing flame retardants.

12. A fire-resistant product comprising a substrate and a fire-resistant polyurethane coating composition applied on the substrate, the fire-resistant polyurethane coating composition comprising:
a. an aromatic isocyanate component;
b. a polyol component;
c. an intumescent component;
wherein the aromatic structure content in the polyurethane backbone is ≥24 wt %, wherein “aromatic structure content in the polyurethane backbone” is defined as the percentage of all atoms' weight in the conjugated planar cyclic ring structure in the precursors to the sum of precursors to form the polyurethane, and precursors in the polyurethane coating composition include all polyols, isocyanates and prepolymers of isocyanates, if present.

13. The fire-resistant product of claim 12, wherein the substrate is selected from wood, metal, ceramic, polymeric materials or concrete.
